(19) United States
(12) Patent Application Publication
(10) Pub. No.: US 2009/0215005 A1
(43) Pub. Date: Aug. 27, 2009

(54) MULTI-PURPOSE DENTAL MIRRORS AND RELATED DENTAL INSTRUMENTS

(76) Inventor: David Brock, Gainesville, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/917,307

(22) PCT Filed: May 19, 2006
(86) PCT No.: PCT/US2006/019526

§ 371 Date: Jun. 5, 2008

Related U.S. Application Data
(60) Provisional application No. 60/690,254, filed on Jun. 14, 2005.

(51) Int. Cl. A61C 3/00

(52) U.S. Cl. 433/31

(57) ABSTRACT

A dental instrument according to various embodiments of the invention includes: (1) an elongate handle that has a first end and a second end, (2) a mirror attached adjacent the first end of the handle, and (3) a needle guide adjacent the second end of the handle. The needle guide includes an inlet portion and an outlet portion, and the needle guide is adapted to receive an end portion of a hypodermic needle adjacent the inlet portion and to physically guide the end portion of the hypodermic needle from the inlet portion to the outlet portion. According to one embodiment, the needle guide comprises a tunnel that extends through at least a portion of the elongate handle, hi another embodiment, the needle guide comprises a groove that extends adjacent an exterior surface of the elongate handle.

### BACKGROUND OF THE INVENTION

Currently, during dental procedures, it is often necessary to inject a drug, such as a local anesthetic, into a patient's gums. This procedure is often painful for the patient and awkward for the dentist to execute. For example, it is often difficult to execute a particular dental injection without interference from the patient's tongue. Accordingly, there is a need for improved medical instruments for facilitating injections and for reducing the discomfort that is often associated with these injections.

### BRIEF SUMMARY OF THE INVENTION

According to various embodiments of the invention, a dental instrument includes (1) an elongate handle that has a first end and a second end, (2) a mirror attached adjacent the first end of the handle, and (3) a needle guide adjacent the second end of the handle. The needle guide includes an inlet portion and an outlet portion, and the needle guide is adapted to receive an end portion of a hypodermic needle adjacent the inlet portion and to physically guide the end portion of the hypodermic needle from the inlet portion to the outlet portion. According to one embodiment, the needle guide comprises a tunnel that extends through at least a portion of the elongate handle. In another embodiment, the needle guide comprises a groove that extends adjacent an exterior surface of the elongate handle.

In another embodiment of the invention, the dental instrument comprises an elongate member that has a blunt end and a needle guide. The needle guide has both an inlet portion and an outlet portion, and the outlet portion of the needle guide is defined adjacent the blunt end of the elongate member. The blunt end is configured for exerting pressure on a first area of tissue that is adjacent to a second area of tissue that is to be injected by a hypodermic needle. The needle guide is adapted to receive an end portion of a hypodermic needle adjacent to the inlet portion and to physically guide the end portion of the hypodermic needle from the inlet portion to the outlet portion.

In another embodiment of the invention, a dental instrument includes: (1) an elongate handle that has a first end and a second end; and (2) a mirror attached adjacent the first end of the elongate handle. The handle defines a recess adjacent the second end of the handle that is adapted to substantially conform to a portion of a patient's tooth. The dental instrument is adapted to allow a user to: (1) position the dental mirror so that a portion of a particular tooth is received within the recess; (2) while the portion of the particular tooth is disposed within the recess, use the dental instrument to exert a lateral force on the particular tooth; and (3) observe whether the particular tooth moves in response to the lateral force being exerted on the particular tooth.

According to other embodiments of the invention, a needle guide includes an inlet portion, an outlet portion, and an interior passage defined between the inlet portion and the outlet portion. The needle guide is adapted to receive an end portion of a hypodermic needle adjacent the inlet portion and to physically guide the end portion of the hypodermic needle from the inlet portion to the outlet portion. In addition, the needle guide is adapted to be removably attached adjacent to a dental mirror.

### BRIEF DESCRIPTION OF THE SEVERAL VIEWS OF THE DRAWINGS

In the description below, reference is made to the accompanying drawings, which are not necessarily drawn to scale, and wherein:

FIG. 1 is a rear view of a dental instrument according to one embodiment of the present invention.

FIG. 2 is a view of the base end of the dental instrument of FIG. 1.

FIG. 3 is a side view of the dental instrument of FIG. 1.

FIG. 4 is a perspective view showing the dental instrument of FIG. 1 in use.

FIG. 5 is a rear view of a dental instrument according to another embodiment of the present invention.

FIG. 6 is a view of the base end of the dental instrument of FIG. 5.

FIG. 7 is a side view of the dental instrument of FIG. 5.

### DETAILED DESCRIPTION OF THE INVENTION

The present inventions will now be described with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

### A. Exemplary Structure of the Dental Instrument

A dental instrument according to one embodiment of the invention is a dental mirror having a needle guide that is integrated into the dental mirror's handle. The structure and function of one such dental instrument is described below.

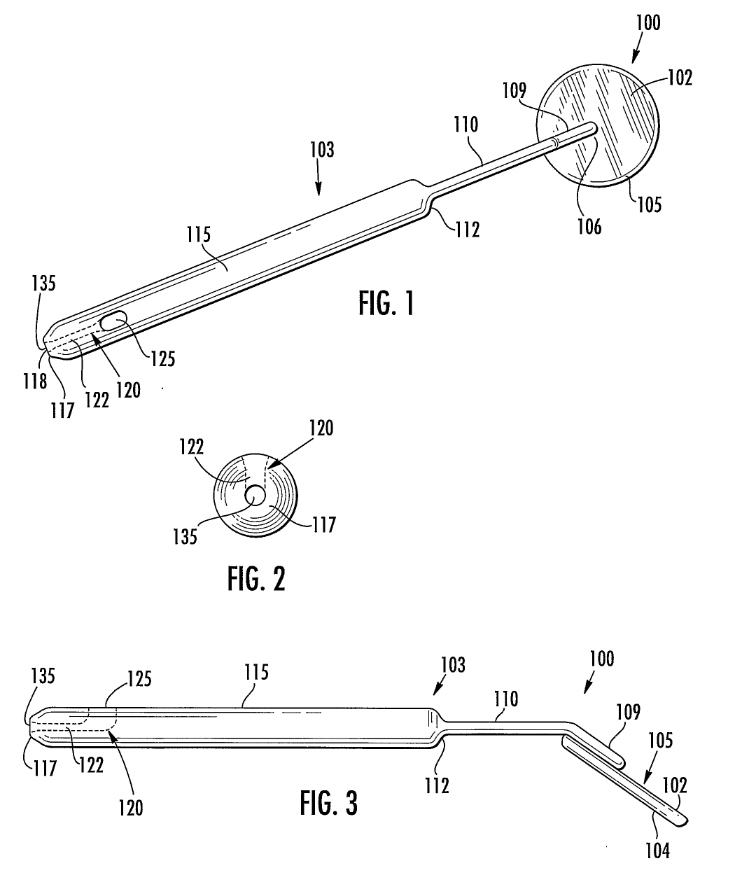

A dental instrument 100 according to a particular embodiment of the invention is shown in FIGS. 1-3. As may be understood from these figures, in this embodiment, the dental instrument 100 comprises an elongate handle 103 having a base end 117 and a mirror attachment end 106. The dental instrument 100 further comprises a mirror portion 105 that is attached adjacent (and preferably to) the dental instrument's handle 103. In one embodiment, this mirror portion 105 is attached adjacent the handle's mirror attachment end 106.

Exemplary Structure of the Mirror Portion

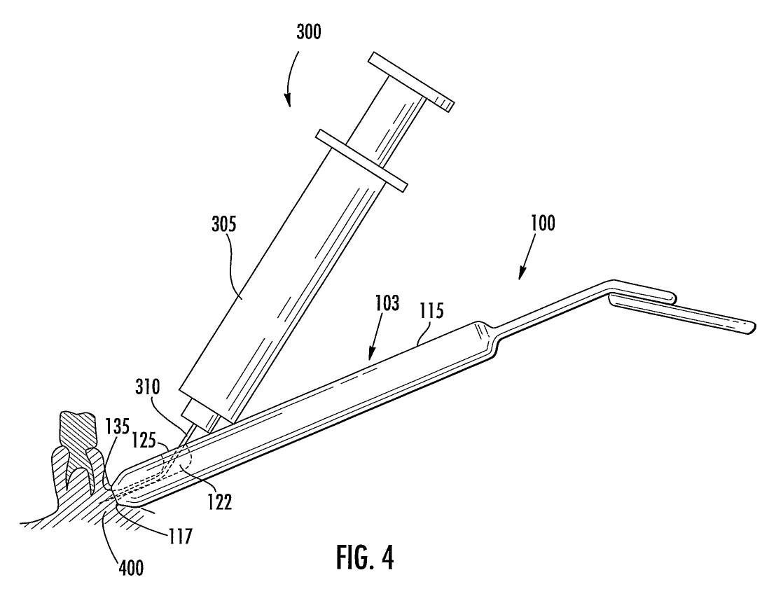

As may be understood from FIGS. 1 and 3, in one embodiment of the invention, the dental instrument 100 comprises a substantially circular mirror portion 105, such as those currently used in standard dental mirrors. In this embodiment, the mirror portion 105 includes a front, mirrored side 104 and a rear side 102 that, in one embodiment, is not mirrored.

In a particular embodiment of the invention, the mirror portion 105 has a substantially circular cross section and has diameter of about one inch. However, the mirror portion 105 may be of any other suitable size or shape. For example, in various embodiments of the invention, the mirror portion's cross section may be substantially in the shape of an oval, a half-circle, or a square (e.g., having smoothed corners).

Exemplary Structure of the Handle

As may be understood from FIGS. 1 and 3, in various embodiments of the invention, the dental instrument's handle 103 comprises an elongate base portion 115, an intermediate portion 110, and a mirror support portion 109. In the embodiment shown in FIGS. 1 and 3, the handle's intermediate portion 110 extends between the handle's base portion 115 and the handle's mirror support portion 109.

In various embodiments of the invention, the handle's base portion 115 defines a base end 117, and a second end 112 that is spaced apart from the base end 117. The elongate base portion 115 may, for example, have a substantially circular cross section. In various embodiments, the diameter of the base portion's cross section is between ⅛″ and ¾″. In various other embodiments, the elongate base portion 115 may have a cross-section in the form of any other suitable shape (e.g., a hexagon, a diamond, or a half circle).

As may be understood from FIGS. 1 and 3, in various embodiments of the invention, the handle's elongate intermediate portion 110 extends outwardly from the second end 112 of the handle's base portion 115. Also, in certain embodiments of the invention, the central axis of the handle's intermediate portion 110 lies substantially within the same plane as the central axis of the handle's base portion 115. In addition, in a particular embodiment of the invention, the central axis of the handle's base portion 115 and the central axis of the handle's intermediate portion 110 are substantially coaxial.

In the embodiment shown in FIGS. 1 and 3, the handle's mirror connecting portion 109 is elongated and has a substantially circular cross section. In this embodiment, the central axis of the mirror connecting portion 109 is disposed within substantially the same plane as the central axis of the handle's base portion 115 and intermediate portion 110. However, in this embodiment, the mirror connecting portion 109 is preferably positioned so that the central axis of the handle's mirror connecting portion 109 forms an angle of between 5 and 90 degrees with the central axis of the handle's intermediate portion 110. This facilitates attaching a mirror portion 105 at an obtuse angle relative to both the handle's base portion 115 and intermediate portion 110 as shown in FIG. 3.

In the embodiment of the invention shown in FIGS. 1 and 3, the handle's base portion 115, intermediate portion 110, and mirror attachment portion 109 are preferably manufactured as a single piece. However, in alternative embodiments, the handle's various components may be manufactured separately and attached together using known manufacturing techniques (or other fastening techniques).

As noted above, in various embodiments of the invention, the handle 103 comprises a needle guide 120 that may be disposed, for example, adjacent the handle's base end 117. For example, in the embodiment shown in FIGS. 1-3, the handle's base portion 115 defines a needle guide 120 that is adapted to guide the tip of a hypodermic needle between: (1) a needle inlet opening 125 that is defined within a side surface of the handle's base portion 115; and (2) a needle outlet opening 135 that is defined within the handle's base end 117. In this embodiment, the needle guide 120 comprises an interior passage 122 that extends between the needle inlet opening 125 and the needle outlet opening 135.

In various embodiments of the invention, at least a portion of (and preferably a majority of) the needle guide's interior passage 122 has a curved (e.g., substantially circular or oval) cross-section. Also, as may be understood from FIG. 3, the interior passage 122 may be substantially L-shaped. Accordingly, the needle guide 120 may be dimensioned to flex a hypodermic needle as the leading end of the hypodermic needle is guided from the needle guide's inlet opening 125 to the needle guide's outlet opening 135. In additional embodiments, the interior passage 122 may be in any other general configuration (e.g., in a substantially straight or gradually curved configuration).

In various embodiments, the handle's inlet opening 125 has a substantially oval cross section and is positioned so that its major axis is substantially parallel to the central axis of the handle's base portion 115. In addition, a portion of the needle guide's interior passage 122 (e.g., the portion that is immediately adjacent the needle guide's inlet opening 125) may be substantially fiumel-shaped (with the inlet end of the funnel being disposed immediately adjacent the inlet opening 125). This helps to guide a hypodermic needle from the inlet opening 125, into the interior passage 122, and toward the needle guide's outlet opening 135.

In various embodiments of the invention, the needle guide's outlet opening 135 has a curved (e.g., substantially circular or oval) cross section, and may be dimensioned so that the portion of the handle 103 immediately adjacent to the outlet opening 135 restricts (and preferably substantially prevents) the lateral movement of a portion of a hypodermic needle that is disposed within the outlet opening 135 as that portion of the hypodermic needle passes through the outlet opening 135. For example, in various embodiments of the invention, at least a portion of the outlet opening 135 has a width that is substantially the same as the diameter of a particular size of hypodermic needle with which the needle guide 120 is configured to be used. More specifically, in one embodiment of the invention, the outlet opening 135 is substantially circular and has a radius that is substantially the same as the radius of a particular size of needle with which the needle guide 120 is configured to be used. In various embodiments of the invention, the outlet opening 135 is substantially circular and has a radius that is less than 200%, 100%, and/or 50% greater than the radius of a particular size of needle with which the needle guide 120 is configured to be used. For example, in various embodiments, the outlet opening 135 is substantially circular and has a radius that is less than 200%, 100%, and/or 50% greater than the radius of a 25, 27 or 30 gauge needle.

In certain embodiments of the invention, the needle guide's outlet opening 135 is substantially centered in relation to at least two opposing sides of the handle's base end 117. Also, in a particular embodiment, the needle guide's outlet opening 135 is substantially centered in relation to the handle's base end 117. For example, in the embodiment of the invention shown in FIGS. 1-3, the needle guide's outlet opening 135 and the perimeter of the handle's base end 117 are substantially co-centric. In this embodiment, both the needle guide's outlet opening 135 and the perimeter of the handle's base end 117 are substantially circular. However, as will be understood by one skilled in the relevant field in light of this disclosure, the needle guide's outlet opening 135 and/or the perimeter of the handle's base end 117 may be in any other suitable shape, size, or configuration.

In various embodiments of the invention, the medical instrument's handle 103 includes a recess 118 adjacent its base end 117. This recess 118 may, for example, be adapted to substantially conform to a portion of a tooth. For example, in one embodiment, the recess 118 is substantially funnel shaped, with the inlet portion of the fimnel being disposed immediately adjacent the handle's base end 117. This serves to allow a user to check the mobility of a tooth by: (1) positioning the dental instrument 100 so that a portion of the tooth is received within the handle's recess 118; (2) while the portion of the tooth is disposed within the handle's recess 118, using the dental instrument 100 to exert a lateral force on the tooth; and (3) observing whether the tooth moves in response to the lateral force being exerted on the tooth.

The various components of the dental instrument 100 may be made of any suitable material. For example, in various embodiments, the handle's base portion 115 is preferably made of hard plastic or metal. In various embodiments of the invention, the needle guide's interior passage 122 may be lined with a low-friction coating, such as Teflon, to facilitate the movement of a hypodermic needle through the needle guide 120. In various embodiments of the invention, at least a portion of the handle 103 is made of a transparent material, such as hard, clear plastic. In particular embodiments, at least a portion of the handle 103 adjacent the needle guide's interior passage 122 is transparent. This preferably allows users to see the position of the end of a hypodermic needle as it passes through the needle guide 120.

### B. Exemplary Operation of Dental Instruments According to Various Embodiments

As will be understood by one skilled in the field of dentistry in light of this disclosure, a dentist may use a dental instrument 100 according to various embodiments of the invention in a customary manner to view various interior portions of a patient's mouth.

In addition, as noted above, and as shown in FIG. 4, a dentist may use a dental instrument 100 according to various embodiments of the invention to facilitate executing a dental injection. In order to do so, the user first prepares a syringe/needle assembly 300 for an injection in the standard manner. The user then positions the dental instrument 100 so that the needle guide's outlet opening 135 is disposed immediately adjacent a desired entry point for the injection (e.g., on a patient's gums or on a patient's hard palate). Next, while maintaining the dental instrument 100 in this position relative to the desired entry point, the user presses the base end 117 of the dental instrument's handle 103 against the portion of tissue that is immediately adjacent the desired entry point. In various embodiments, this causes the base end 117 of the dental instrument's handle 103 to exert pressure in a substantially circumferential pattern around the desired entry point.

Next, while continuing to exert pressure around the desired entry point as described above, the user inserts the needle 310 of the needle/syringe assembly 300 into the needle guide's inlet opening 125. While performing this step, the user preferably maintains the needle/syringe assembly 300 so that the central axis of the syringe 305 forms an angle of between about 10 and 45 degrees with the central axis of the handle's base portion 115 (See FIG. 4).

Next, preferably while maintaining the syringe 305 in this general angular orientation relative to the dental instrument's handle 103, the user moves the needle/syringe assembly 300 toward the handle's base end 117. As a result, the tip of the needle 310 passes through the needle guide's interior passage 122 and toward the needle guide's outlet portion 135. During this process, the needle 310 may flex slightly, as shown in FIG. 4, to substantially conform to the shape of the needle guide's interior passage 122.

The user then continues moving the needle/syringe assembly 300 toward the handle's base end 117 until the end of the needle 310 passes through the needle guide's outlet portion 135 and enters the tissue adjacent the dental instrument's outlet portion 135. Once the end of the needle 310 is in the desired position within the tissue, the user uses the syringe 305 to inject a drug, such as an anesthetic, into the tissue through the needle 310.

Finally, the user withdraws the needle 310 first from the tissue, and then from the needle guide 120. This is preferably done while the user is still using the dental instrument 100 to apply pressure to the patient's gums. Finally, the user removes the dental instrument 100 from the patient's mouth.

### C. Additional Embodiments of the Invention

It should be understood that the present invention may be embodied in many different forms and configurations. Several of these alternative embodiments are described below.

Alternative Outlet Opening Positions

While the needle guide's outlet opening 135 is described above as being centered in relation to the base end 117 of the dental instrument's handle 103, this outlet opening 135 may be formed in any appropriate location adjacent the handle's base end 117 (e.g., immediately adjacent a side edge of the handle's base end 117). Similarly, the outlet opening 135 may be defined at any other appropriate location on the dental instrument 100. For example, the outlet opening 135 may be defined in a side portion of the dental instrument's handle 103 (e.g., in a side portion of the dental instrument's handle 103 adjacent the dental instrument's base end 117).

Embodiments Incorporating a Needle Guide Groove

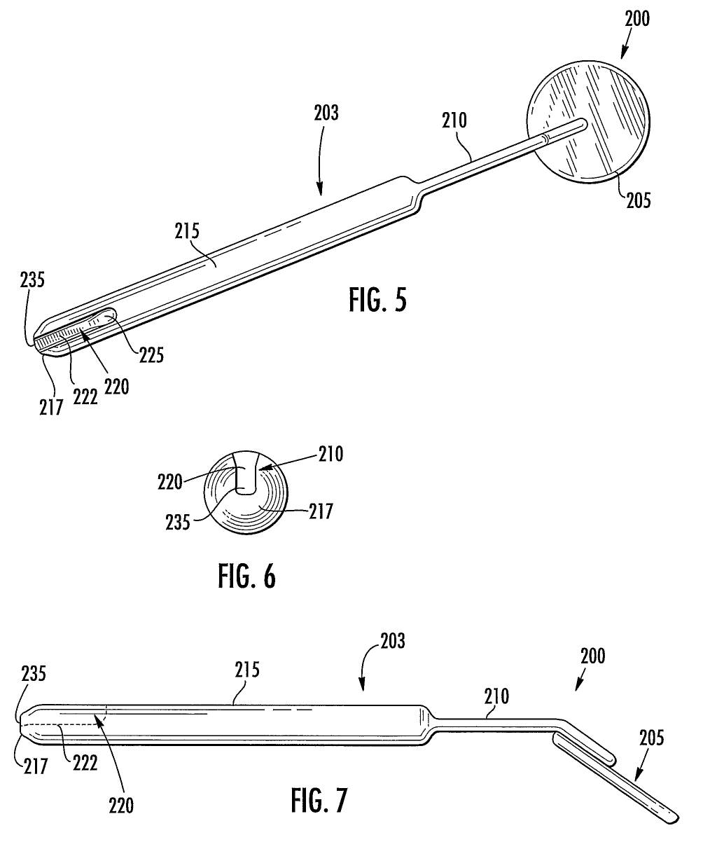

In addition, while the needle guide 120 is described above as including an interior passage 122 (which may be, for example, in the form of a tunnel passing through a portion of the dental instrument's handle 103), as shown in FIGS. 5-7, the needle guide may alternatively be in the form of a needle guide groove 220 that is formed in the sidewall of the dental instrument's handle 203. As may be understood from FIGS. 5-7, in various embodiments of the invention, this needle guide groove 220 may have a substantially U-shaped cross-section, and may be aligned so that the central axis of the needle guide groove 220 is substantially parallel to the central axis of the handle's base portion 215.

In various embodiments of the invention, the needle guide groove 220 includes an inlet portion 225 that is disposed adjacent a side edge of the base portion 215 of the dental instrument's handle 203. In one embodiment, this inlet portion 225 is spaced apart from the handle's base end 217 by less than about 2 inches. The needle guide groove 220 also preferably includes an outlet portion 235. As shown in FIG. 5, this outlet portion 235 is preferably substantially centered between opposite side edges of the dental instrument's handle 203. For example, in various embodiments, the outlet portion 235 is substantially centered relative to the handle's base end 217.

In various embodiments, the needle guide groove 220 is preferably adapted to receive the tip of a hypodermic needle adjacent the needle guide groove's inlet portion 225 and to guide the tip of the hypodermic needle along the needle guide groove 220 toward the needle guide groove's outlet portion 235. In various embodiments, the needle guide groove 220 is adapted to restrict (and preferably to substantially prevent) the lateral movement of the hypodermic needle as the hypodermic needle is guided by the needle guide groove 220 to the needle guide groove's outlet portion 235.

To use this embodiment of the invention to perform an injection, a user first prepares a syringe/needle assembly for an injection in the standard maimer. The user then positions the dental instrument 200 so that the needle guide's outlet portion 235 is disposed immediately adjacent a desired entry point for the injection. Next, while maintaining the dental instrument 200 in this position relative to the desired entry point, the user presses the base end 217 of the dental instrument's handle 203 against the tissue that is immediately adjacent the desired entry point. This causes the base end 217 of the dental instrument's handle 203 to exert pressure in a substantially circumferential (and/or substantially U-shaped) pattern around the desired entry point.

Next, while continuing to exert pressure on the patient's tissue as described above, the user positions the needle of the needle/syringe assembly adjacent the needle guide's inlet portion 225 while gently urging the hypodermic needle toward the needle guide groove's interior portion 222. While performing this step, the user preferably maintains the needle/syringe assembly so that the central axis of the needle/syringe assembly forms an angle of between 10 and 40 degrees with the central axis of the handle's base portion 215.

Next, preferably while maintaining the syringe in this general angular orientation relative to the dental instrument's handle 203, the user moves the needle/syringe assembly toward the handle's base end 217. During this process, the user continues to urge the hypodermic needle toward the needle guide groove's interior portion 222 to maintain the needle within the needle guide groove 220. As a result, the tip of the needle passes along the needle guide groove 220 and toward the needle guide groove's outlet portion 235. During this process, the leading end portion of the needle may flex slightly to substantially conform to the shape of the needle guide groove 220.

The user then continues moving the needle/syringe assembly toward the handle's base portion 217 in this manner until the needle passes adjacent the needle guide's outlet portion 235 and enters the patient's tissue. Once the end of the needle is in the desired position within the tissue, the user uses the syringe to inject medicine into the tissue through the needle.

Finally, the user withdraws the needle first from the tissue, and then from the needle guide groove 220. (This may be done, for example, while the user is still using the dental instrument to apply pressure to the patient's tissue as discussed above.) Finally, the user removes the dental instrument 200 from the patient's mouth.

Alternatively, the user may move the dental instrument 200 away from the point of injection (and out of the patient's mouth) while the needle is still injected into the patient's tissue. This is done by moving the dental instrument 200 so that the needle moves laterally through the open end of the needle guide groove 220.

Embodiments having a Detachable Needle Guide

While the needle guide is described above as being integrated into the dental instrument's handle, a dental instrument according to an alternative embodiment of the invention comprises a dental mirror (e.g., a standard dental mirror), and a needle guide that is selectively detachable from the dental mirror. In various embodiments, the needle guide is adapted to selectively clip onto a standard dental mirror adjacent the base end of the dental mirror so that the needle guide's outlet opening is disposed adjacent a side edge of the dental mirror's base end. In this embodiment of the invention, the size and shape of the needle guide may be, for example, substantially the same as the size and shape of the needle guide 120 described above in regard to FIGS. 1-3.

Embodiments that don't Include a Dental Mirror

A dental instrument according to various further embodiments of the invention are in substantially the same form as the base portion 115 of either the dental instrument 100 shown in FIGS. 1-3, or the dental instrument 200 shown in FIGS. 4-6. However, in these embodiments, the dental instrument does not include a mirror portion 205.

Further Alternative Embodiments

While the invention is described above as being implemented in the form of a dental instrument, it should be understood that the instrument may take the form of any suitable medical instrument, and may be used in medical fields other than dentistry. For example, a needle guide according to a particular embodiment of the invention is configured for reducing the pain associated with making an injection into a patient's arm. In this embodiment of the invention, the medical instrument is configured for exerting pressure circumferentially around a desired injection point in a patient's arm (e.g., in the mainer described above), and for guiding a needle into the desired injection point while continuing to apply pressure adjacent the desired injection point in this manner. By the same token, the invention may be adapted for use in performing nasal or vaginal injections, in performing injections during surgery, or during the course of other types of medical procedures.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended exemplary inventive concepts. Although specific terms are employed herein, they are used in a generic and descriptive sense only and not for purposes of limitation.

1. A dental instrument comprising:
an elongate handle having a first end and a second end;
a mirror attached adjacent said first end of said handle; and
a needle guide adjacent said second end of said handle wherein:
said needle guide comprises an inlet portion and an outlet portion;
said needle guide comprises a tunnel that extends through at least a portion of said elongate handle; and
said needle guide is adapted to receive an end portion of a hypodermic needle adjacent said inlet portion and is adapted to physically guide said end portion of said hypodermic needle from said inlet portion to said outlet portion.

2. (canceled)

3. The dental instrument of claim 1, wherein said tunnel's interior passage is substantially curved.

4. The dental instrument of claim 1, wherein said tunnel's interior passage is substantially L-shaped.

5. The dental instrument of claim 1, wherein a cross section of said tunnel's interior passage is substantially oval shaped.

6. The dental instrument of claim 1, wherein at least a portion of said tunnel's interior passage is substantially funnel shaped.

7. (canceled)

8. (canceled)

9. The dental instrument of claim 1, wherein said needle guide is selectively detachable from said handle.

10. The dental instrument of claim 1, wherein said second end further defines a recess, said recess being adapted to substantially conform to a portion of a tooth.

11. The dental instrument of claim 10, wherein said recess is substantially funnel shaped.

12. The dental instrument of claim 1, wherein said inlet's opening is substantially circular.

13. The dental instrument of claim 1, wherein said inlet's opening is substantially oval shaped.

14. A dental instrument comprising:
an elongate member having a blunt end that is configured for exerting pressure on a first area of tissue, said first area of tissue being adjacent a second area of tissue that is to be injected by a hypodermic needle; and
a needle guide having both an inlet portion and an outlet portion, said outlet portion being defined adjacent said blunt end of said elongate member, wherein:
said needle guide comprises an interior passage, said interior passage extending between said inlet portion and said outlet portion, and wherein said interior passage (a) is substantially curved, (b) is substantially L-shaped, (c) comprises a portion having a substantially oval cross-section, or (d) comprises a portion that is substantially funnel shaped; and
said needle guide is adapted to receive an end portion of a hypodermic needle adjacent said inlet portion and is adapted to physically guide said end portion of said hypodermic needle from said inlet portion to said outlet portion.

15. (canceled)

16. (canceled)

17. The dental instrument of claim 14, wherein said interior passage comprises a portion that is substantially oval in cross-section.

18. The dental instrument of claim 14, wherein said interior passage is substantially curved.

19. The dental instrument of claim 14, wherein said interior passage is substantially L-shaped.

20. The dental instrument of claim 14, wherein said inlet portion is substantially oval shaped.

21. The dental instrument of claim 14, wherein said inlet portion is substantially funnel shaped.

22. The dental instrument of claim 14, wherein said outlet portion is substantially oval shaped.

23. The dental instrument of claim 14, wherein said inlet portion is adjacent a side surface of said elongate member and said outlet portion is adjacent said blunt end.

24. The dental instrument of claim 14, wherein said elongate member further comprises a mirror attachment end opposite said blunt end, said mirror attachment end adapted for receiving a mirror.

25. The dental instrument of claim 14, wherein said dental instrument further comprises a mirror attached adjacent a second end of said elongate member, said second end being opposite said blunt end.

26. The dental instrument of claim 25, wherein said mirror is selectively attachable adjacent said second end of said elongate member.

27. A needle guide comprising:
an inlet portion;
an outlet portion, and
an interior passage defined between said inlet portion and said outlet portion, wherein:
said needle guide is adapted to receive an end portion of a hypodermic needle adjacent said inlet portion and to physically guide said end portion of said hypodermic needle from said inlet portion to said outlet portion, and
said needle guide is adapted to be removably attached adjacent a dental mirror.

28. The needle guide of claim 27, wherein said needle guide is adapted to be selectively attached adjacent said dental mirror in a snap-on manner.

29. A dental instrument comprising:
an elongate handle having a first end and a second end; and
a mirror attached adjacent said first end of said elongate handle, wherein:
said handle defines a recess adjacent said second end of said handle, said recess being adapted to substantially conform to a portion of a patient's tooth, and said dental instrument is adapted to allow a user to:
position said dental mirror so that a portion of a particular tooth is received within said recess;
while said portion of said particular tooth is disposed within said recess, using said dental instrument to exert a lateral force on said particular tooth; and
observing whether said particular tooth moves in response to said lateral force being exerted on said particular tooth.

30. The dental instrument of claim 14, wherein said interior passage comprises a portion that is substantially funnel shaped.

31. The dental instrument of claim 14, wherein needle guide is selectively detachable from said blunt end.
